(19) United States
(12) Patent Application Publication
(10) Pub. No.: US 2021/0312497 A1
(43) Pub. Date: Oct. 7, 2021

(54) ANALYZING RANDOMIZED GEO EXPERIMENTS USING TRIMMED MATCH

(71) Applicant: Google LLC, Mountain View, CA (US)

(72) Inventors: Aiyou Chen, Palo Alto, CA (US); Timothy C. Au, San Mateo, CA (US)

(73) Assignee: Google LLC, Mountain View, CA (US)

(21) Appl. No.: 16/834,915

(22) Filed: Mar. 30, 2020

(51) Int. Cl. G06Q 30/02; G06F 16/29; G06F 16/28

(52) U.S. Cl. CPC G06Q 30/0254; G06Q 30/0261; G06F 16/288; G06F 16/29; G06Q 30/0252

(57) ABSTRACT

Systems, methods and computer-readable storage media utilized to prepare experimental datasets for experimental analysis systems. One method includes identifying, by one or more processing circuits, a dataset of a plurality of geographic pairs associated with a geo experiment. The method further includes calculating, by the one or more processing circuits, a difference in input data and a difference in response data between the first geographic region and the second geographic region of each geographic pair. The method further includes calculating, by the one or more processing circuits, a plurality of outcome estimates. The method further includes selecting, by the one or more processing circuits, a first subset of geographic pairs of the plurality of different subsets of geographic pairs based a first outcome estimate of the plurality of outcome estimates that is about a prespecified value on the outcome estimates and providing the selected subset of geographic pairs.

### BACKGROUND

The present disclosure relates generally to the field of geographic experiment models. In a computer networked environment such as the internet, geography-based experiments have been used in an effort to predict the impact of content.

### SUMMARY

Some implementations relate to a method of preparing experimental datasets for experimental analysis systems, the method implemented by one or more processing circuits. The method includes identifying, by one or more processing circuits, a dataset of a plurality of geographic pairs associated with a geo experiment, the dataset of the plurality of geographic pairs comprising input data, response data, and location identifiers associated with each geographic region, wherein the response data is a result of an action associated with the input data, and wherein each geographic pair of the dataset of the plurality of geographic pairs comprises a first geographic region associated with a treatment subset and a second geographic region associated with a control subset. Further, the method includes calculating, by the one or more processing circuits, a difference in input data and a difference in response data between the first geographic region and the second geographic region of each geographic pair. Further, the method includes calculating, by the one or more processing circuits, a plurality of outcome estimates based on the difference in response data and the difference in input data for each of a plurality of different subsets of geographic pairs, wherein each output estimate comprises a different subset of geographic pairs, and wherein each subset of geographic pairs comprises a different number of geographic pairs. Further, the method includes selecting, by the one or more processing circuits, a first subset of geographic pairs of the plurality of different subsets of geographic pairs based a first outcome estimate of the plurality of outcome estimates that is about a prespecified value on the outcome estimates and providing, by the one or more processing circuits, the selected subset of geographic pairs.

In some implementations, the method further includes generating, by the one or more processing circuits, one or more predictions based on the selected subset of geographic pairs. In various implementations, the one or more predictions are based on a bivariate analysis, the bivariate analysis comprising an empirical relationship between each geographic pair, the empirical relationship indicative of an association prediction of each geographic pair and a difference prediction of each geographic pair. In some implementations, in response to generating the one or more predictions the method further includes, sending, by the one or more processing circuits to an entity computing device, an entity notification including the one or more predictions and the selected subset of geographic pairs. In various implementations, selecting the first subset of geographic pairs of the plurality of different subsets of geographic pairs further comprises determining a fixed trim rate based on the minimizing a plurality of asymptotic variances. In some implementations, calculating the plurality of asymptotic variances of the dataset of the plurality of geographic pairs further comprises calculating an asymptotic variance for each of the plurality of different subsets of geographic pairs. In various implementations, each asymptotic variance is associated with at least one of the response data, the input data, or the location identifiers. In some implementations, the first geographic region associated with the treatment subset and the second geographic region associated with the control subset is randomly selected from each geographic pair.

Some implementations relate to a system with at least one processing circuits. The at least one processing circuit can be configured to identify a dataset of a plurality of geographic pairs associated with a geo experiment, the dataset of the plurality of geographic pairs comprising input data, response data, and location identifiers associated with each geographic region, wherein the response data is a result of an action associated with the input data, and wherein each geographic pair of the dataset of the plurality of geographic pairs comprises a first geographic region associated with a treatment subset and a second geographic region associated with a control subset. Further, the at least one processing circuit can be configured to calculate a difference in input data and a difference in response data between the first geographic region and the second geographic region of each geographic pair. Further, the at least one processing circuit can be configured to calculate a plurality of outcome estimates based on the difference in response data and the difference in input data for each of a plurality of different subsets of geographic pairs, wherein each output estimate comprises a different subset of geographic pairs, and wherein each subset of geographic pairs comprises a different number of geographic pairs. Further, the at least one processing circuit can be configured to select a first subset of geographic pairs of the plurality of different subsets of geographic pairs based a first outcome estimate of the plurality of outcome estimates that is about a prespecified value on the outcome estimates and provide the selected subset of geographic pairs.

In some implementations, the at least one processing circuit can be configured to generate one or more predictions based on the selected subset of geographic pairs. In various implementations, the one or more predictions are based on a bivariate analysis, the bivariate analysis comprising an empirical relationship between each geographic pair, the empirical relationship indicative of an association prediction of each geographic pair and a difference prediction of each geographic pair. In some implementations, in response to generating the one or more predictions the at least one processing circuit can be configured to, send, to an entity computing device, an entity notification including the one or more predictions and the selected subset of geographic pairs. In various implementations, selecting the first subset of geographic pairs of the plurality of different subsets of geographic pairs is further configured to determine a fixed trim rate based on the minimizing a plurality of asymptotic variances. In some implementations, calculating the plurality of asymptotic variances of the dataset of the plurality of geographic pairs is further configured to calculate an asymptotic variance for each of the plurality of different subsets of geographic pairs, and wherein each asymptotic variance is associated with at least one of the response data, the input data, or the location identifiers. In various implementations, the first geographic region associated with the treatment subset and the second geographic region associated with the control subset is randomly selected from each geographic pair. In some implementations, the first geographic region and the second geographic region are associated with a target population.

Some implementations relate to one or more computer-readable storage media having instructions stored thereon that, when executed by at least one processing circuit, cause the at least one processing circuit to perform operations. The operations include identifying a dataset of a plurality of geographic pairs associated with a geo experiment, the dataset of the plurality of geographic pairs comprising input data, response data, and location identifiers associated with each geographic region, wherein the response data is a result of an action associated with the input data, and wherein each geographic pair of the dataset of the plurality of geographic pairs comprises a first geographic region associated with a treatment subset and a second geographic region associated with a control subset. Further, the operations include calculating a difference in input data and a difference in response data between the first geographic region and the second geographic region of each geographic pair. Further, the operations include calculating a plurality of outcome estimates based on the difference in response data and the difference in input data for each of a plurality of different subsets of geographic pairs, wherein each output estimate comprises a different subset of geographic pairs, and wherein each subset of geographic pairs comprises a different number of geographic pairs. Further, the operations include selecting a first subset of geographic pairs of the plurality of different subsets of geographic pairs based on a first outcome estimate of the plurality of outcome estimates that is about a prespecified value on the outcome estimates and providing the selected subset of geographic pairs.

In some implementations, the operations further include generating one or more predictions based on the selected subset of geographic pairs and in response to generating the one or more predictions, sending, to an entity computing device, an entity notification including the one or more predictions and the selected subset of geographic pairs. In various implementations, the one or more predictions are based on a bivariate analysis, the bivariate analysis comprising an empirical relationship between each geographic pair, the empirical relationship indicative of an association prediction of each geographic pair and a difference prediction of each geographic pair. In some implementations, selecting the first subset of geographic pairs of the plurality of different subsets of geographic pairs further comprises determining a fixed trim rate based on the minimizing a plurality of asymptotic variance.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of a geographic experiment system and associated environment, according to an illustrative implementation;

FIG. 2 is a flow chart for a method of preparing experimental datasets for experimental analysis systems, according to an illustrative implementation;

FIGS. 3A-3B are example model performance representations comparing the trimming model, binomial model, and the empirical model, according to illustrative implementations;

FIGS. 4A-4F are example model performance representations comparing the trimming model, binomial model, and the empirical model, according to illustrative implementations;

FIG. 5 is a block diagram of a computing system, according to an illustrative implementation.

### DETAILED DESCRIPTION

The present disclosure pertains to systems and methods that relate generally to preparing experimental datasets for experimental analysis systems. In some embodiments, geographic experiments (i.e., geo experiments, e.g., randomized causal geo experiments) are performed on pairs of matched geos (i.e., geographic regions), such that one geo is selected (e.g., randomly or pseudo-randomly) to be the control geo and the other geo is selected to be the treatment geo. That is, the control geo and the treatment geo can be utilized in models that execute geographic experiments to provide predictions. However, the geo experiment model predictions, performed after geo experiments, depend on well-matched geos to produce an accurate prediction. Thus, the systems and methods described herein describes a method to automatically trim (i.e., remove) the most unmatched geo pairs post-geo experiment based on selecting an outcome estimate to increase the accuracy of causal post-experimental analysis system predictions.

In some systems, to measure the impact of content provider initiatives, content providers employ a randomized paired geo experiment model which partitions a geographic region of interest into a set of smaller non-overlapping “geos” that are regarded as the units of experimentation rather than the individual users themselves. Indeed, since their introduction, geo experiments have gone on to become a standard tool for the causal measurement of content provider initiatives. However, geo experiments also introduce some additional complexity which makes geo experiment model predictions (e.g., post-geo experiment) difficult. Often only a small number of heterogeneous experimental units are available for experimentation, which makes it challenging to obtain reliable geo experiment model predictions with existing methods. Thus, the ability to utilize outcome estimates in the preparation of datasets post-geo experiments for experimental analysis system, such that datasets of paired geos are adaptively selected (e.g., trimmed) to remove poorly matched geos based on an outcome estimate, provides randomized paired geo experiment models with accurate data to produce accurate predictions. This causal approach allows randomized paired geo experiment models to provide significant improvements to predictions post-geo experiment such that the accuracy of the prediction and the performance of the randomized paired geo model is improved and as a result, enabling content providers to make informed decisions about their initiatives. Therefore, aspects of the present disclosure address problems in preparing geographic data by introducing a causal trimming approach that removes unmatched geo pairs post-geo experiment and provides closely matched geo pairs to causal post-experimental analysis systems such that the models can improve performance and produce accurate predictions for content providers.

Accordingly, the present disclosure is directed to systems and methods for preparing geographic datasets for experimental analysis systems. In some implementations, the described systems and methods involve utilizing one or more processing circuits. The one or more processing circuits allow receiving of a dataset of a plurality of geographic regions including response data, input data, and location identifiers of each geographic region, wherein the response data is a result of an action associated with the input data. The one or more processing circuits can then be utilized to calculate a difference in input data and a difference in response data and as a result, a plurality of outcome estimates can be calculated. In the present disclosure geo experiments can be performed on a pair of matched geos (i.e., experiment units). That is, the geo experiments can determine an empirical relationship between each geographic pair, where the empirical relationship is indicative of an association prediction of each geographic pair and a difference prediction of each geographic pair.

In some implementations, the one or more processing circuits can generate one or more predictions based on selected subset of geographic pairs. That is, the one or more processing circuits can perform a bivariate analysis to determine an empirical relationship between each geographic pair. In various implementations, the one or more processing circuits can also provide a notification in conclusion of a geo experiment performed by the geo experiment circuit that can include the selected subset of geographic pairs utilized during the experiment.

In situations in which the systems discussed here collects personal information about users and/or entities, or may make use of personal information, the users and/or entities are provided with an opportunity to control whether programs or features collect user information and/or entity information (e.g., information about a user's social network, social actions or activities, profession, a user's preferences, or a user's current location), or to control whether and/or how to receive content from the content server that may be more relevant to the user and/or entity. In addition, or in the alternative, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user and/or entity have control over how information is collected about the user and/or entity and used by a content server.

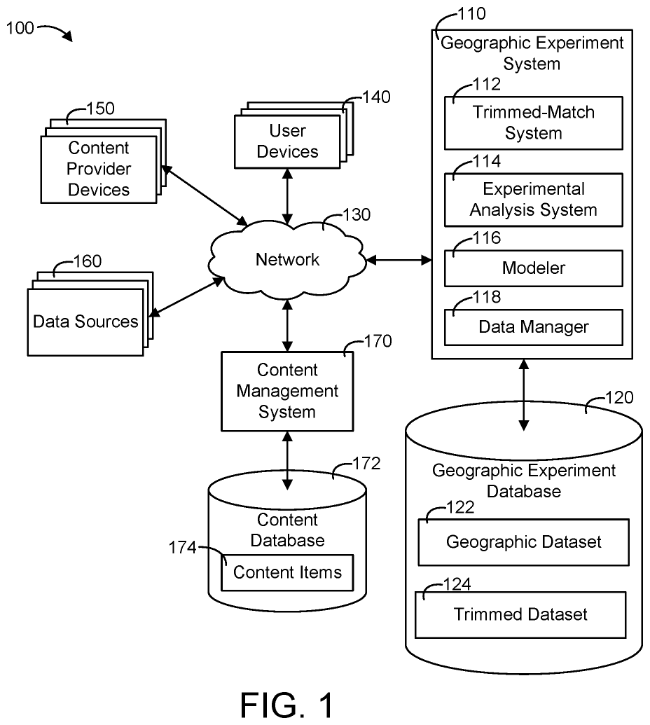

Referring now to FIG. 1, a block diagram of a geographic experiment system 110 and associated environment 100 is shown, according to an illustrative implementation. One or more user devices 140 (e.g., smartphones, tablets, computers, etc.) may be used by a user to perform various actions and/or access various types of content, some of which may be provided over a network 130 (e.g., the Internet, LAN, WAN, etc.). A “user” or “entity” used herein may refer to an individual operating user devices 140, interacting with resources or content items via the user devices 140, etc. The user devices 140 may be used to send data to the geographic experiment system 110 or may be used to access websites (e.g., using an internet browser), media files, and/or any other types of content. In some implementations, the user devices 140 have enabled location services which can be tracked over network 130. Locations services may use GPS or other technologies to determine a location of user devices 140.

A content management system 170 may be configured to select content for display to users within resources (e.g., webpages, applications, etc.) and to provide content items to the user devices 140 over the network 130 for display within the resources. The content from which the content management system 170 selects items may be provided by one or more content providers via the network 130 using one or more content provider devices 150. In some implementations, the content management system 170 may select content items from content providers to be displayed on the user devices 140. In such implementations, the content management system 170 may determine content to be published in one or more content interfaces of resources (e.g., webpages, applications, etc.).

The geographic experiment system 110 may be used by content providers in an effort to quantify the impact (e.g., input, response) of content items. The geographic experiment system 110 can include one or more processors (e.g., any general purpose or special purpose processor), and can include and/or be operably coupled to one or more transitory and/or non-transitory storage mediums and/or memory devices (e.g., any computer-readable storage media, such as a magnetic storage, optical storage, flash storage, RAM, etc.). In various implementations, the geographic experiment system 110 and the content management system 170 can be implemented as separate systems or integrated within a single system (e.g., the content management system 170 can be configured to incorporate some or all of the functions/capabilities of the geographic experiment system 110). The geographic experiment system 110 may be configured to communicate over network 130 via a variety of architectures (e.g., client/server, peer-to-peer, etc.). The geographic experiment system 110 can be configured to provide a variety of interfaces for setting up geographic experiments, monitoring progress of geographic experiments, analyzing results of geographic experiments, and trimming geographic pairs associated with the results of geographic experiments.

The geographic experiment system 110 can be communicably and operatively coupled to the geographic experiment database 120 which may be configured to store a variety of information relevant to geographic experiments (collectively referred to herein as “geo experiments”) performed by a modeler 116. Information may be received from user devices 140, content provider devices 150, data sources 160, and/or content management system 170, for example. The geographic experiment system 110 can be configured to query the geographic experiment database 120 for information and store information in the geographic experiment database 120. In various implementations, the geographic experiment database 120 includes various transitory and/or non-transitory storage mediums. The storage mediums may include but are not limited to magnetic storage, optical storage, flash storage, RAM, etc. The geographic experiment database 120 and/or the geographic experiment system 110 can use various APIs to perform database functions (i.e., managing data stored in the geographic experiment database 120). The APIs can be but are not limited to SQL, NoSQL, NewSQL, ODBC, JDBC, etc.

In some implementations, a content provider submits a request to perform a geo experiment to geographic experiment system 110 and provides information about the request (e.g., content items, campaign identification, desired change in input level, geographic areas to target, etc.) which may be stored in geographic experiment database 120 (e.g., geographic dataset 122). In addition, geographic experiment system 110 may be configured to retrieve data via network 130 (e.g., user activity data, content campaign data, etc.) which may be stored in the geographic dataset 122 of geographic database 120.

Geographic experiment system 110 can be configured to communicate with any device or system shown in environment 100 via network 130. The geographic experiment system 110 can be configured to receive information from the network 130. The information may include browsing histories, cookie logs, television content data, printed publication content data, radio content data, and/or online content activity data. The geographic experiment system 110 can be configured to receive and/or collect the interactions that the user devices 140 have on the network 130. This information may be stored as geographic data in a geographic dataset 122.

Data sources 160 may include data collected by the geographic experiment system 110 by receiving interaction data from the content provider devices 150 and/or user devices 140. The data may be content input (e.g., content spend) and response (e.g., content revenue) for particular media channels (e.g., television, Internet content, radio, billboards, printed publications) at one or more points in time. The content input may include spending on television content, billboard content, Internet content (e.g., search content spend, or display content spend), etc. The data may be data input for particular entities or users (e.g., patients, customer purchases, internet content items) at one or more points in time. The content input may include data associated with a plurality of entities, a plurality of users, a specific entity, a specific user, etc. Data sources 160 may be also be various data aggregating systems and/or entities that collect content data. The geographic experiment system 110 can receive geographic sub-region data from the data sources 160 via the network 130. This information may be stored as geographic sub-region data in the geographic dataset 122.

The geographic experiment system 110 can be configured to send information and/or notifications relating to various metrics (e.g., predictions) or models it determines, generates, or fits to the content provider devices 150. This may allow a user of one of the content provider devices 150 to review the various metrics or models which the geographic experiment system 110 determines. Further, the geographic experiment system 110 can use the various metrics to identify opportune times to make contact with a user or appropriate amounts (e.g., an optimal mixed media input) to input on various media channels (e.g., television advertising, Internet advertising, radio advertising, etc.). The geographic experiment system 110 can cause a message to be sent to the content management system 170 and/or the content provider devices 150 indicating that the content management system 170 should make contact with a certain user at a certain time and/or a content campaign operate with certain parameters.

The geographic experiment system 110 may include one or more systems (i.e., computer-readable instructions executable by a processor) and/or circuits (i.e., ASICs, Processor Memory combinations, logic circuits, etc.) configured to perform various functions of the geographic experiment system 110. In some implementations, the systems may be or include a trimmed-match system 112, an experimental analysis system 114, a modeler 116, and a data manager 118.

It should be understood that various implementations may include more, fewer, or different systems than illustrated in FIG. 1, and all such modifications are contemplated within the scope of the present disclosure.

The data manager 118 can be configured to generate various data structures stored in the geographic experiment database 120. For example, the data manager 118 can be configured to generate one or more geographic regions (geos). The geos may be a data structure included in the geographic dataset 122 and indicate various geographic areas. For example, the geographic areas could be states, cities, countries, or any other geographic area. The geos can be generated by the data manager 118 by grouping one or more smaller geographic regions together (e.g., sub-regions). For example, the geos could be generated by grouping multiple states into East coast, West coast, and Midwest. Further, multiple cities within a particular state could be grouped together to form a predefined number of the geos.

The data manager 118 can also be configured to receive a plurality of geographic sub-region data for each of the sub-regions that make up the geos. For example, for a particular state, the state may have five geos that are each include five different cities. The data manager 118 can be configured to receive the geographic sub-region data (e.g., stored in geographic dataset 122) for each of the cities of each of the five geos. Based on a correlation between the geographic sub-regions, the geos, and an indication of location in the received data, the geographic sub-region data can be sorted (grouped) into geo-level data by the data manager 118. In some embodiments, the data manager 118 can be configured to receive data for the geos as a whole (e.g., stored in geographic dataset 122) instead of data specific to particular sub-regions that make up the geos.

The received data that the data manager 118 receives can be data that geographic experiment system 110 aggregates and/or data that the geographic experiment system 110 receives from the data sources 160.

The data manager 118 can also be configured to communicate with content management system 170 via network 130 in order to determine a set of one or more content items associated with a content provider to be analyzed during a geo experiment. In addition, data manager 118 may be configured to determine one or more characteristics associated with the one or more content items. Characteristics may include associated keywords used in a search query, website views, video views (e.g., via YouTube), content views, content clicks, etc. For example, data manager 118 may be configured to determine (e.g., via a campaign ID or other identifier) content items associated with a content campaign for a new restaurant. In this example, data manager 118 may also determine that the set of content items is presented based on a set of target keywords (e.g., restaurant, new restaurant, restaurant in geographic location, etc.). Data manager 118 may also be configured to initiate a change in input level associated with a set of content items for analysis during a geo experiment.

The data manager 118 can further be configured to retrieve and analyze user activity data including actions performed by user devices 140 over network 130. In some implementations, data manager 118 retrieves user activity data and creates an activity log with one or more log entries. The activity log can span over any specified time period (e.g., past month, past week, etc.) and can be specific to users based on any constraints (e.g., users in France, users in Los Angeles, Android users in Boston, etc.). The data manager 118 may be configured to use a filtered activity log in order to determine a subset of users (i.e., a subset of the users associated with the original activity log). The subset of users may be users that have a likelihood of being exposed to the content items being analyzed. In addition, data manager 118 may be configured to retrieve user activity data related to a response metric being analyzed during a geo experiment.

The geographic dataset 122 may include subsets of data that each include response data, content input data (e.g., input data), a content type, control variables, and/or a location identifier associated with each geo. The data may be for one or more points in time over an interval (e.g., data for each hour out of a day, data for each day out of a year, data for each month out of a decade, etc.) The content type may indicate a particular media channel of the set of data, for example, television, radio, Internet content, newspaper or magazine content, etc. The response data can be a result of an action associated with the input data. That is, the response data may indicate particular amounts of revenue at particular times. In some embodiments, the response is number of conversions, number of sales, number of account registrations, etc. The input data may indicate particular amounts (e.g., fiat currency) of content input for the content type at particular times. The input data may further indicate a number of content runs. The geographic dataset 122 may include time series data structures indicating amounts of input data, response data, for various media channels and/or various geographic regions over time.

The modeler 116 may be configured to designate geographic regions as pairs (collectively referred to herein as “geo pairs”). A geographic region of interest (e.g., the United States) can be partitioned into a set of smaller geographic areas, or “geos”. These geos can provide comparable sets of users for testing during a geo experiment. Details of how geos are chosen are beyond the scope of this disclosure, however geos generally are large enough (e.g., at least larger than a postal code) to ensure content serving accuracy and the ability to monitor the desired response metric at the geo level. In the United States, for example, one possible set of geos is the 210 designated marketing areas (DMAs) as defined by Nielsen Media Research. After a set of two or more geos for the geo experiment are identified, modeler 116 can determine geo pairs. That is, geos are paired up so that two geos in the same pair are more comparable than across pairs based on pre-geo experiment response data.

For example, the table below describes a plurality of geos associated with a number of interactions. In one example, it pairs the geos based on the difference in interactions.

TABLE 1
Before pairing:

| | geo | interactions (million) |
|---|---|---|
| 1 | Los Angeles | 25M |
| 2 | Chicago | 15M |
| 3 | Miami | 11M |
| 4 | Washington | 8M |
| 5 | Milwaukee | 4M |
| 6 | Austin | 2M |
| 7 | Seattle | 7M |
| 8 | Kansas City | 9M |
| 9 | Philadelphia | 14M |
| 10 | Boston | 12M |

TABLE 2
After pairing:

| pair | geo.1 | difference (million) | geo.2 |
|---|---|---|---|
| 1 | Los Angeles | 10M | Chicago |
| 2 | Miami | 3M | Washington |
| 3 | Milwaukee | 2M | Austin |
| 4 | Seattle | 2M | Kansas City |
| 5 | Philadelphia | 2M | Boston |

As shown above, one example of how modeler 116 may determine geo pairs based on a set of geos. Further, with n geo pairs, there are 2n possible geo pair assignments. Due to randomization, on average, the geo pairs can have similar overall response data (e.g., interactions), but they may differ somewhat for each particular geo pair assignment. However, if each pair is well-matched (e.g., similar overall response data) or if the number of pairs is large (e.g., one hundred pairs, one thousand pairs, one million pairs, etc.), the difference for a random geo pair assignment is close to zero (i.e., high precision) with high probability.

In some implementations, within each pair, the modeler 116 may randomly assign one of the pairs to treatment and the other to control. During geo experiments, a change in input level may only be implemented for geos in the treatment group, whereas geos in the control group may remain unchanged. The designation of geos into control or treatment groups can be implemented in a variety of ways, including randomization (as described above) or designation by a content provider.

The modeler 116 also can be configured to analyze results (e.g., response metrics of geo pairs) of randomized geo experiments. In some implementations, modeler 116 retrieves data via network 130 related to one or more response metrics being analyzed during the experiment. For example, if the response metric being measured is physical entity response, modeler 116 can be configured to retrieve entity response data over network 130. A variety of response metrics can be tracked during a geo experiment. In some implementations, the response metric is an offline response metrics such as physical entity responses. Entity responses may be determined using location information (e.g., location identifier) from one or more user devices 140. In some implementations, the response metric may include user interactions in a mapping interface, which may be indicative of an intention to visit a physical location or entity. User interactions with the mapping interface may include, for example, searching for entity locations within the control group or treatment group, requesting directions to a location of an entity within the control group or the treatment group, and/or navigating to a location of an entity within the control group or the treatment group. Online response metrics such as response data (e.g., conversion data) or any other user-specific action that can be measured and defined as a response event (e.g., online response, provision of requested data via an online form, etc.) can also be used. Modeler 116 can retrieve data from content management system 170, user devices 140 (e.g., through the use of cookies or other identifiers), content provider devices 150, and/or data sources 160, for example. In some implementations, modeler 116 can store geo experiments results in the geographic dataset 122.

Content provider devices 150 may specify an input (e.g., spend amount), a set of one or more content items (e.g., some or all items associated with a campaign) to be analyzed, as well as a desired response metric to be recorded during a geo experiment (e.g., randomized geo experiment). The modeler 116 can be configured to perform the geo experiment (e.g., randomized paired geo experiment) which may include determining one or more characteristics (e.g., search queries, industry, vertical, subject matter) associated with the set of content items. The characteristic may be used to filter an activity log including a list of each user computing device (e.g., user computing devices 140) actions in order to determine a subset of users that have a likelihood of being exposed to the content items. Each user of the subset of users may belong to a geo being analyzed during a geo experiment (e.g., may be physically present within the geo, may have a place of residence or work inside the geo, etc.).

During a randomized geo experiment, the modeler 116 can designate G to be the set of geos for a target population. Given a geo g E G, let (S_{g}, R_{g})∈R² denote its observed bivariate outcome, where S_{g} is content input and R_{g} is the response variable. Geo g's can denote potential outcome under the control and treatment content serving conditions as (S_{g}^{(C)}, R_{g}^{(C)}) and (S_{g}^{(T)}, R_{g}^{(T)}) respectively, where the modeler 116 can observe one of these two bivariate potential outcomes for each geo g. For each geo g, there can be two unit-level causal effects caused by the new content strategy: incremental content input and incremental response, which can be defined by S_{g}^{(T)}−S_{g}^{(C)} and R_{g}^{(T)}−R_{g}^{(C)} respectively. The incremental response on content input (iROCI) with respect to geo g, denoted as θ_{g}, can be the ratio of incremental response to incremental content input (Equation 1):

$${θ}_{g} = \frac{{R}_{g}^{( T )} - {R}_{g}^{( C )}}{{S}_{g}^{( T )} - {S}_{g}^{( C )}}$$

and the iROCI with respect to the population G can be defined similarly (Equation 2):

$${θ}^{*} = \frac{\frac{1}{\vert G \vert} {\sum }_{g ∈ G} {R}_{g}^{( T )} - {R}_{g}^{( C )}}{\frac{1}{\vert G \vert} {\sum }_{g ∈ G} {S}_{g}^{( T )} - {S}_{g}^{( C )}}$$

Content providers may find θ* to be a more informative causal prediction of content performance, which is the parameter used hereafter.

In a randomized geo experiment, where a subset of G can be randomly selected for treatment and another subset for control, modeler 116 may obtain unbiased predictions of average incremental response and average incremental content input. The prediction (e.g., utilizing modeler 116) can then give a natural estimate of θ* (e.g., referred to as the empirical estimator) (Equation 3.1):

$${\hat{θ}}^{( emp )} = \frac{\frac{1}{\vert T \vert} {\sum }_{g ∈ T} {R}_{g} - \frac{1}{\vert C \vert} {\sum }_{g ∈ C} {R}_{g}}{\frac{1}{\vert T \vert} {\sum }_{g ∈ T} {S}_{g} - \frac{1}{\vert C \vert} {\sum }_{g ∈ C} {S}_{g}}$$

where T and C denote the set of geos in treatment and in control, respectively.

The prediction can also utilize a model-free estimator of θ* (e.g., referred to as the binomial sign test) (Equation 3.2):

$${\hat{θ}}^{( b i n o m )} = {M}_{n} ( θ ) = {\sum }_{i = 1}^{n} I ( {ϵ}_{i} ( θ > 0 ) - \frac{1}{2}$$

With ϵᵢ(θ) is ϵᵢ (θ)=Yᵢ−Xᵢθ and where I(⋅) can be the indicator function, and while the Wilcoxon signed-rank test can be defined similarly (Equation 3.3):

$${\hat{θ}}^{( rank )} = {M}_{n} ( θ ) = {\sum }_{i = 1}^{n} sgn ( {ϵ}_{i} ( θ ) ) \cdot rank ( \vert {ϵ}_{i} ( θ ) \vert )$$

However, geo experiments often introduce some additional complexity which makes the causal prediction of the iROCI more difficult. In particular, the no interference component of the stable unit treatment value assumption. That is, the presumption that the treatment applied to one experimental unit does not affect the outcome of another experimental unit can be particularly challenging to satisfy since it may require the geos to be defined such that spillover effects (e.g. from consumers traveling across geo boundaries) can be negligible. Thus, minimizing spillover effects can often result in only a small number of highly heterogeneous geos being available for experimentation, and therefore the distributions of {Sg:g∈G} and {Rg:g∈G} can be very heavy-tailed. For example, a heavy-tailed distribution may include a distribution that analyzes how many cups of coffee does each person drink per week. In this example, 80% of the distribution may be people that drink three cups of coffee per week, whereas 1% of the distribution may be people that drink twenty cups of coffee per week. As shown in this example, the distribution may be heavy-tailed towards the 1% of coffee drinkers than drink twenty cups of coffee per week. As a result, the empirical estimator, binomial sign test, and Wilcoxon signed-rank test defined in Equation 3.1, Equation 3.2, and Equation 3.3 respectively can be unreliable.

Rearranging Equation 1 (Equation 4):

R_{g}^{(C)}−θ_{g}S_{g}^{(C)}=R_{g}^{(T)}−θ_{g}S_{g}^{(T)}

Based on this analysis, modeler 116 can generate predictions to solve for the value of θ*, which can provide an estimate for the population iROCI.

The following table describes the notation as it shall be used hereafter. The notation is denoted as follows:
R_{ic}, S_{ic}: Response and content input for control geo
Rᵢₜ, Sᵢₜ: Response and content input for treatment geo
Yᵢ=Rᵢₜ−R_{ic}: Difference in the responses
Xᵢ=Sᵢₜ−S_{ic}: Difference in content input
ϵᵢ (θ)=Yᵢ−Xᵢθ: Difference in response background noise with respect to θ

In randomized geo experiments, the distribution of ϵᵢ(θ*) can be symmetric about a prespecified value (e.g., zero) for i=1, . . . , n. Therefore, the expected value of ϵᵢ(θ*) can be zero. To calculate the iROCI, it is the goal of the experimental analysis system 114 to accurately predict the value of θ* based on ϵᵢ(θ*). However, an accurate prediction may be flawed when geo pairs are poorly matched. That is, it can be difficult to know whether or how much the two geo pairs are comparable during the pre-geo experiment period, because for example, geos are all different from each other, and some can be much larger than others (i.e., geo heterogeneity), and/or the responses between two geos (or two groups) may be quite comparable during the pre-geo experiment period, but may become quite different during a geo experiment even if there is no experiment intervention (i.e., temporal dynamics). For examples, these can be caused by factors such as weather or other marketing factors which cannot be controlled for the geo experiment.

Accordingly, the trimmed-match system 112 can be configured to trim poorly-matched geo pairs (e.g., heterogeneous pairs) based on a trimming model after a geo experiment has been run. In other words, the trimmed-match system 112 can be configured to select a subset of geographic pairs of a plurality of different subsets of geographic based on an outcome estimate of a plurality of outcome estimates. In some implementations, the trimmed-match system 112 retrieves geo pair data from the geographic dataset 122 related to the geo pairs analyzed during a particular geo experiment. In general, even with a careful randomized matched-pairs design (e.g., how the geo pairs are matched), where the two geos within each pair are well-matched based on pre-geo experiment data, due to temporal dynamics (e.g., weather or other content factors which cannot be controlled by the randomized geo experiment), some pairs may be poorly-matched during the geo experiment even if there were no experiment intervention. That is, poorly-matched pairs in the geo experiment results can produce result that may skew model predictions.

Thus, the trimmed-match system 112 can utilize a trimming model to remove (or trim) poorly-match geo pairs based on an outcome estimate (e.g., difference in input and difference in response data between the treatment geo and control geo of each geographic pair) to provide a trimmed dataset (e.g., selected subset of geographic pairs) to the experimental analysis system 114. That is, by removing certain geos that may disproportionally affect the results of a causal geo experiment, a trimming model can be utilized to provide improved geo pair matches (e.g., trimmed dataset) to the experimental analysis system 114.

The trimmed-match system 112 can utilize a trimming model to utilize the following derivation of the trimming model assuming a geo experiment has been executed and that ϵ₁(θ)≤ϵ₂(θ)≤ϵ₃(θ)≤ . . . ≤ϵₙ(θ) to be the corresponding order statistics. This trimming model can utilize a fixed value, λ, to be a fixed trim rate, where 0≤λ<½. A trimmed mean statistic can be defined as the following equation (Equation 5):

$${\overline{ϵ}}_{n λ} ( θ ) ≡ \frac{1}{n - 2 m} {\sum }_{i = m + 1}^{n - m} {ϵ}_{i} ( θ )$$

where m is the minimal integer greater or equal to [nλ]. It should be noted that λ must satisfy n−2m≥1, otherwise all members of the set of geos would be trimmed away. Following the derivations above, the trimmed mean statistic can have an expected value of zero. Therefore, the trimmed-match system 112 can determine one or more roots (e.g., outcome estimates), given a fixed value λ that can satisfy the trimmed match equation below (Equation 6):

ϵ̅_{nλ}(θ*)=0

When multiple roots exist, the trimmed-match system 112 can utilize a trimming model to choose the root which minimizes a statistic (e.g., symmetric deviation), in part using the equation below (Equation 7):

$${D}_{n λ} ( θ ) ≡ \frac{1}{n - 2 m} {\sum }_{i = m + 1}^{n - m} \vert {ϵ}_{i} ( θ ) + {ϵ}_{n - i + 1} ( θ ) \vert$$

which can measure the symmetric deviation from θ. A Trimmed Match estimator can be formally defined as (Equation 8):

\hat{θ}_{λ}^{(trim)}=argmin{D_{nλ}(θ):ϵ_{nλ}(θ)=0}

Thus, when two geos in the ith pair are “perfectly” matched, trimmed-match system 112 can expect ϵᵢ(θ*)=0. That is, if λ=0, then no trimming takes place and \hat{θ}_{λ}^{(trim)} coincides with the empirical estimator \hat{θ}^{(trim)} from Equation 3.1. It can also be understood that the Trimmed Match estimator can directly estimate θ* without determining either the incremental response or the incremental input. Further, the Trimmed Match estimator can be utilized after trimming the geo pairs that are poorly matched in terms of the ϵᵢ(\hat{θ}_{λ}^{(trim)}) values.

Therefore, \hat{θ}_{λ}^{(trim)} trims the poorly matched pairs in the sense of ϵᵢ(θ*) and predict iROCI based on the un-trimmed pairs. The statistical framework to solve for the trimmed match prediction is formally defined as (Algorithm 1):

Input {(xᵢ, yᵢ): 1≤i≤n} and trim rate λ>0; Output: roots of Equation 6.
(i) Reorder the pairs {(xᵢ, yᵢ): 1≤i≤n} such that xᵢ< . . . <xₙ; Calculate {θᵢⱼ: 1≤i≤j≤n} and order them such that θᵢ_{₁}ⱼ_{₁}<θᵢ_{₂}ⱼ_{₂}<= . . . θᵢ_{_{N}}ⱼ_{_{N}}.
(ii) Start with θ=−∞ and initialize the set of untrimmed indices with:

$$I ← \{ i : ⌈ n λ ⌉ < i \leq n - ⌈ n λ ⌉ \}$$

$$Calculate : \\ a ← {\sum }_{i ϵ I} {y}_{i} and b ← {\sum }_{i ϵ I} {x}_{i}$$

Initialize two ordered sets θ₁={ } and θ₂={ }
(iii) For k=1, . . . , N:

(a) If iₖ ∈I and jₖ ∉I, then update,

I←I+{jₖ}−{iₖ},

a←a+yⱼ_{ₖ}−yᵢ_{ₖ}

b←b+xⱼ_{ₖ}−xᵢ_{ₖ}

and append a/b to θ₁ and θᵢ_{ₖ}ⱼ_{ₖ} to θ₂, i.e.,

$${θ}_{1} ← {θ}_{1} + \{ \frac{a}{b} \} \\ {θ}_{2} ← {θ}_{2} + \{ {θ}_{{i}_{k} {j}_{k}} \}$$

(b) If iₖ∉I and jₖ∈I, then update,

I←I+{iₖ}−{jₖ}

and repeat the similar procedure as in (a).

(c) Otherwise, continue.

(iv) Output a subset of θ₁:

(a) Append ∞ to θ₂;

(b) For k=1, . . . , |θ₁|,
(1) Output θ₁[k] if f θ₂[k]≤θ₁[k]≤θ₂[k+1]

For ease of technical derivation, it can be considered the situation where the n pairs of geos are an independent and identically distributed random sample drawn from an infinite population consisting of highly heterogeneous pairs of geos.

Under Section I of the statistical framework, let {(xᵢ, yᵢ): 1≤i≤n} be a set of independent and identically distributed random variables based on some population distribution P. Under Section III of the statistical framework the distribution of ϵᵢ(θ*)(1≤i≤n) can be symmetric about zero.

The trimmed-match system 112 utilizing the trimming model can correctly solve the trimmed match equation (i.e., Equation 6) above based on Algorithm 1, utilizing a fixed trim rate to determine which pairs of geos in the randomized geo experiment to exclude based on how well they match. The geo pairs that are matched the most poorly are trimmed from the set, while maintaining the pairs that are matched very well (e.g., trimmed dataset) for the experimental analysis system 114. Algorithm 1 looks at all candidate values of θ as it grows from −∞ to ∞, and identifies the set of thresholds where the ordering of ϵᵢ(θ) changes whenever θ passes those thresholds.

In order for the Algorithm 1 to work properly, a proper trim rate must be chosen. The trimmed-match system 112 can utilize a trimming model to determine a trim rate for trimmed match equation as follows (Equation 9):

\hat{λ}=argmin

[symbol]

And by minimizing the asymptotic variance (e.g., a type of standard error) of \hat{θ}_{λ}^{(trim)}. The equation for an estimate of asymptotic variance can be found in the equation below (Equation 10):

$$= \frac{\hat{E} ( {ϵ}^{2} ⩓ {q}^{2} )}{{[ \hat{E} ( X \cdot I ( \vert ϵ \vert \leq q ) ) ]}^{2}}$$

In Equation 10, the value of Ê(ϵ²∧q²) is defined as (Equation 11):

$$\hat{E} ( {ϵ}^{2} ⩓ {q}^{2} ) ≡ \frac{1}{n} ( m ( {\hat{ϵ}}_{m + 1}^{2} + {\hat{ϵ}}_{m + 1}^{2} ) + {\sum }_{i = m + 1}^{n - m} {\hat{ϵ}}_{i}^{2} )$$

and Ê(X·I(|ϵ|≤q)) is defined as (Equation 12):

$$\hat{E} ( X \cdot I ( \vert ϵ \vert \leq q ) ) = \frac{1}{n} {\sum }_{i = 1}^{n} X \cdot 1 ( {\hat{ϵ}}_{m + 1} \leq {\hat{ϵ}}_{i} \leq {\hat{ϵ}}_{n - m} )$$

where \hat{ϵ}=Yᵢ−\hat{θ}_{λ}^{(trim)} Xᵢ. The value for the trim rate can be determined by minimizing Equation 10 with respect to λ. Alternatively, a proper trim rate may be choose based on various alternatives (e.g., different types of standard errors) to asymptotic variance. In some implementations, various alternatives include heuristic choice (e.g., availability, rule of thumb, absurdity, common, consistency, contagion, working backward, scarcity, familiarity) based on a default selection and/or historical data (e.g., stored in geographic dataset 122, and/or data sources 160), various approximation by sampling (e.g., bootstrap techniques, cross-validation techniques, statistical test, combined F-test), width of confidence interval (with reference to equation 17 below), and any other any alternatives known to a person of ordinary skill in the art.

Accordingly, the trimmed-match system 112 can utilize the trimming model to remove geo pairs from the dataset of geo pairs based on the trim rate. For example, when the trim rate is equal to zero, no geo pairs are removed. In another example, if the trim rate is equal to 1, two sets of geo pairs are removed based on the symmetric deviation from zero. That is, the largest symmetric deviation geo pair and smallest symmetric deviation geo pair are removed from the dataset of geo pairs. In yet another example, if the trim rate is equal to 2, four sets of geo pairs are removed based on the symmetric deviation from zero. That is, the two largest symmetric deviation geo pair and two smallest symmetric deviation geo pair are removed from the dataset of geo pairs. In some implementation, the dataset of geo pairs that have been trimmed can be referred to as a trimmed dataset of geo pairs and/or selected subset of geographic pairs. In some implementations, the trimmed-match system 112 can be configured to provide the trimmed dataset to the experimental analysis system 114. In various implementations, the trimmed-match system 112 can store the trimmed dataset in the trimmed dataset 124. For example, the trimmed dataset 124 may store trimmed datasets associated with particular content provider. In another example, the trimmed dataset 124 may store trimmed datasets associated with a plurality of content providers.

The experimental analysis system 114 can be configured to analyze the geo experimental data to determine content effectiveness. In one example, the experimental analysis system 114 can provide a prediction for the value of θ* as discussed above. That is, the experimental analysis system 114 can be configured to analyze trimmed datasets and provide predictions to content providers associated with content effectiveness (e.g., content input and response, iROCI).

In some implementations, the iROCI predictions can be content provider specific such that content provider can utilize the information to determine future content input for particular geographic areas and potential response from the content input. In various implementations, the iROCI predictions may be associated with a plurality of content providers. In some implementations, analyzing may include using a machine learning algorithm (e.g., a neural network, convolutional neural network, recurrent neural network, linear regression model, and sparse vector machine). The experimental analysis system 114 can input one or more datasets (e.g., trimmed datasets) into a machine learning model, and receive an output from the model providing predictions to content providers associated with content effectiveness (e.g., content input and response, iROCI).

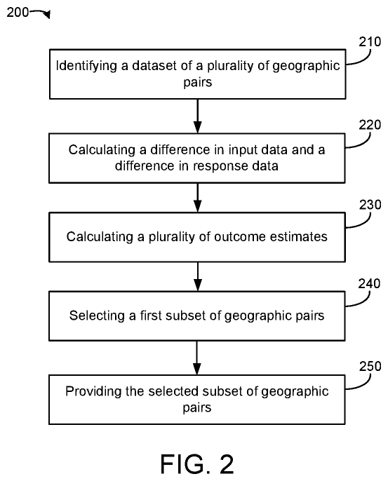

Referring now to FIG. 2, a flowchart for a method 200 of preparing experimental datasets for experimental analysis systems, according to an illustrative implementation. The geographic experiment system 110 and associated environment 100 can be configured to perform the method 200. Furthermore, any computing device described herein can be configured to perform the method 200.

In broad overview of the method 200, at block 210, the one or more processing circuits can identify a dataset of a plurality of geographic pairs. At block 220, the one or more processing circuits can calculate a difference in input data and difference in response data. At block 230, the one or more processing circuits can calculate a plurality of outcome estimates. At block 240, the one or more processing circuits can select a first subset of geographic pairs. At block 250, the one or more processing circuits can provide the selected subset of geographic pairs.

Referring to method 200 in more detail, at block 210, the one or more processing circuits can identify a dataset of a plurality of geographic pairs associated with a geo experiment, the dataset of the plurality of geographic pairs including input data, response data, and location identifiers associated with each geographic region, wherein the response data is a result of an action associated with the input data, and wherein each geographic pair of the dataset of the plurality of geographic pairs includes a first geographic region associated with a treatment subset and a second geographic region associated with a control subset. In some implementations, the dataset of the plurality of geographic pairs can be stored in one or more databases (e.g., geographic experiment database 120 in FIG. 1). In various implementations, the first geographic region associated with the treatment subset and the second geographic region associated with the control subset is randomly selected from each geographic pair. That is, a randomized algorithm that employs a degree of randomness may be utilized to randomly select the treatment and control subsets. For example, the randomized algorithm may use uniformly random bits as an auxiliary input to guide the randomness. In some examples, one or more processing circuits may obverse outside (e.g., data sources, user device selections) that is not predictable to guide the randomness. The input data, response data, and location identifiers associated with each geographic region may be collected from a variety of sources and stored together. In some implementations, the input data, response data may be inferred utilizing one or more machine learning algorithms (e.g., a neural network, convolutional neural network, recurrent neural network, linear regression model, sparse vector machine, or any other algorithm known to a person of ordinary skill in the art). In various implementations, the one or more processing circuits can identify a dataset of a plurality of geographic triplets (e.g., three geos per triplet).

At block 220, the one or more processing circuits can calculate a difference in input data and a difference in response data between the first geographic region and the second geographic region of each geographic pair. That is, the difference in response data between the first geographic region and the second geographic region can be the difference between the treatment subset (e.g., first geographic region) and the control subset (e.g., second geographic region).

At block 230, the one or more processing circuits can calculate a plurality of outcome estimates based on the difference in response data and the difference in input data for each of a plurality of different subsets of geographic pairs, wherein each output estimate (e.g., a root of Equation 6) includes a different subset of geographic pairs, and wherein each subset of geographic pairs includes a different number of geographic pairs. That is, a plurality of subsets of geographic pairs of the dataset of the plurality of geographic pairs can be created. In one example, assume there is 4 geo pairs where Wisconsin (WI) and Minnesota (MN) are geographic pairs, New York (N.Y.) and New Jersey (NJ) are geographic pairs, Texas (TX) and Colorado (CO) are geographic pairs, and Florida (FL) and Arizona (AZ) are geographic pairs. In the above example, one subset of geographic pairs could include WI-MN and NY-NJ. Another subset of geographic pairs could include WI-MN, TX-CO, and NY-NJ. Yet another subset of geographic pairs could include FL-AZ, and TX-CO. Accordingly, any combination of geographic pairs can make a subset of geographic pairs. In some arrangement, the plurality of outcome estimates can be a calculation based on how well-matched the geos are in a particular subset of geographic pairs. In determining how well-matched the geos are in a particular subset of geographic pairs, the one or more processing circuits can utilize the roots of the trimmed mean equation (i.e., Equation 6) to determine the plurality of outcome estimates.

At blocks 240 and 250, the one or more processing circuits can select a first subset of geographic pairs of the plurality of different subsets of geographic pairs based a first outcome estimate of the plurality of outcome estimates that is about a prespecified value on the outcome estimates and provide the selected subset of geographic pairs. In some implementations, the prespecified value may be based on input from a content provider or user. In various implementations, the prespecified value may be based on pre-test data (e.g., before geo experiment) and/or post-test data (e.g., after geo experiment). For example, the prespecified value may be zero, such that the outcome estimate that is closest to zero can be selected. That is, the first outcome estimate can indicate which subset of geographic pairs to provide to the experimental analysis system. In one example, it can be assumed that there are 5 geographic pairs in a dataset of geographic pairs and the prespecified value is zero. The table below illustrates the 5 geographic pairs and data associated with each geographic pair (Table 3).

| Geo Pairs | Rᵢₜ | R_{ic} | Sᵢₜ | S_{ic} | Yᵢ = Rᵢₜ − R_{ic} | Xᵢ = Sᵢₜ − S_{ic} |
|---|---|---|---|---|---|---|
| 1 | 98 | 100 | 2 | 1 | −2 | 1 |
| 2 | 138 | 20 | 4 | 2 | 18 | 2 |
| 3 | 174 | 130 | 6 | 3 | 44 | 3 |
| 4 | 300 | 500 | 10 | 10 | −200 | 0 |
| 5 | 1000 | 601 | 20 | 19 | 399 | 1 |

The notation is denoted as follows:
R_{ic}, S_{ic}: Response and content input for control geo
Rᵢₜ, Sᵢₜ: Response and content input for treatment geo
Yᵢ=Rᵢₜ−R_{ic}: Difference in the responses
Xᵢ=Sᵢₜ−S_{ic}: Difference in content input
ϵᵢ (θ)=Yᵢ−Xᵢθ: Difference in response background noise with respect to θ

Since the prespecified value is zero, θ can be solved utilizing a plurality of different subsets of geographic pairs to determine a plurality of outcome estimates. An outcome estimate with a subset of geographic pairs that includes all the geo pairs, is shown below (i.e., trim rate= 0/5=0):

Trimmed mean{ϵᵢ(θ)}=0

Trimmed mean{ϵᵢ(θ):1,2, . . . 5}=0

If trim rate=0, the trimmed mean statistic can have an expected value of 0 (i.e., the average):

$$0 = mean ( {Y}_{i} ) - mean ( {X}_{i} ) * θ$$

$$mean ( {X}_{i} ) * θ = mean ( {Y}_{i} )$$

$$θ = \frac{mean ( {Y}_{i} )}{mean ( {X}_{i} )}$$

$$θ = \frac{- 2 + 18 + 44 - 200 + 399}{1 + 2 + 3 + 0 + 1}$$

$$θ = \frac{259}{7} = 37$$

| Geo Pairs | ϵᵢ(θ) = Yᵢ − Xᵢθ | | ϵᵢ(θ) |
|---|---|---|---|
| 1 | ϵᵢ(θ) = | −2 − (37 * 1) | −39 |
| 2 | ϵᵢ(θ) = | 18 − (37 * 2) | −56 |
| 3 | ϵᵢ(θ) = | 44 − (37 * 3) | −67 |
| 4 | ϵᵢ(θ) = | −200 − (37 * 0) | −200 |
| 5 | ϵᵢ(θ) = | 399 − (37 * 1) | 362 |

An outcome estimate with a subset of geographic pairs that includes geo pairs 1, 2, and 3, is shown below (i.e., trim rate=⅕=0.2):

$$θ = \frac{mean ( untrimmed {Y}_{i} )}{mean ( untrimmed {X}_{i} )} \\ θ = \frac{- 2 + 18 + 44}{1 + 2 + 3} \\ θ = \frac{60}{6} = 10$$

| Geo Pairs | ϵᵢ(θ) − Yᵢ − Xᵢθ | | ϵᵢ(θ) |
|---|---|---|---|
| 1 | ϵᵢ(θ) = | −2 − (10 * 1) | −12 |
| 2 | ϵᵢ(θ) = | 18 − (10 * 2) | −2 |
| 3 | ϵᵢ(θ) = | 44 − (10 * 3) | 14 |

Other subsets of geographic pairs can also be utilized to calculate one or more outcome estimate. However, in the example shown above, geo pairs 4 and 5 have a significant difference in response compared to the other geo pairs. That is, geo pairs 4 and 5 may be poorly-matched geo pairs and when calculating the outcome estimate for a plurality of different subsets of geographic pairs (e.g., subset: 1, 2, 3 and subset: 1, 2, 3, 4, 5) about the value zero, it can be observed (and shown below) that the subset of geographic pairs that include geo pairs 1, 2, and 3 provide a value about zero. Thus, the subset of geographic pairs associated with geo pairs 1, 2, and 3 can be selected and provided to an experimental analysis system (e.g., experimental analysis system 114 in FIG. 1) and/or any other system described herein. In some arrangements, the selected subset of geographic pairs can be stored in a database (e.g., geographic experiment database 120 in FIG. 1, and in particular trimmed dataset 124).

Furthermore, in determining the plurality of outcome estimates, the significant difference in response as shown in geo pairs 4 and 5 can be indicative of low precision. That is, to utilize well-matched geo pairs, the subset of geographic pairs may be representative of high precision geo pairs. Accordingly, the one or more processing circuits can determine a λ that minimizes the asymptotic variance (i.e., Equation 10, a standard error) of each subset of geographic pairs to determine a fixed trim rate. For example, with reference to the geo experiment above, if λ=0 the fixed trim rate would be

$$\frac{λ}{£ of geo pairs} = \frac{0}{5} = 0 ,$$

resulting in a large standard error (i.e., low precision, not well-matched), since geo pairs 4 and 5 are includes. In another example with reference to the geo experiment above, if λ=1 the fixed trim rate would be

$$\frac{λ}{£ of geo pairs} = \frac{1}{5} = \frac{1}{5} ,$$

resulting in a determination that the subset including geo pairs 1, 2, and 3 should be selected. In other words, the largest Y (i.e., 399—geo pair 5) and smallest Y (i.e., −200—geo pair 4) can be removed from the dataset of geographic pairs.

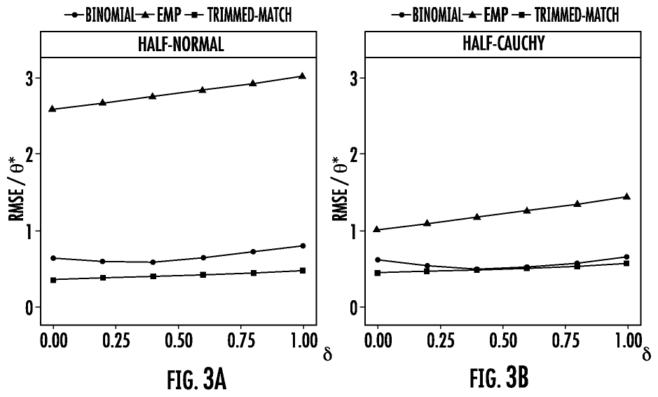

Referring to FIGS. 3A-3B, example model performance representations comparing the trimming model, binomial model, and the empirical model, according to illustrative implementations. FIG. 3A and FIG. 3B illustrate the model performance comparison between \hat{θ}^{(binom)}, \hat{θ}^{(emp)}, and \hat{θ}^{(trim)} during a simulation scenario. In some implementations, the experimental analysis system 114 of FIG. 1 may be configured to execute model performance comparisons. During a simulation scenario, the experimental analysis system 114 may first simulate all the content input and response potential outcomes for each experiment geo, {{S_{g}^{(T)}, S_{g}^{(C)}, R_{g}^{(T)}, S_{g}^{(C)}}: 1≤g≤2n} and pre-specify the geos into n pairs, such that the experimental data can depend on the treatment-control assignment inside each geo pair. In particular, the potential outcomes can be simulated by the experimental analysis system 114 as a function of geo size for each geo g=1, 2, . . . , 2n (Equation 13):

$${z}_{g} = {F}^{- 1} ( \frac{g}{2 n + 1} )$$

where F is either a half-normal distribution or, to introduce more geo heterogeneity, a half-Cauchy distribution.

Geo pairs can be defined as follows: the largest two geos make a pair, the 3rd and 4th largest geos make a second pair, and so on. The potential outcomes for each geo g can then generated as follows:

(i) Response if in control: R_{g}^{(C)}=z_{g};
(ii) Content input if in control: S_{g}^{(C)}=0.1×R_{g}^{(C)};
(iii) Control input if treated: S_{g}^{(T)}=S_{g}^{(C)}×(1+0.25·r), where r>0 is a simulation parameter controlling the intensity of the incremental content input;
(iv) Response if treated: R_{g}^{(T)}=R_{g}^{(C)}+θ_{g}×(S_{g}^{(T)}−S_{g}^{(C)}) wherein θ_{g}=θ*·(1+δ·(−1)^{g}) is the geo-level iROCI, and δ is a simulation parameter controlling the level of deviation from an assumption (Assumption 1), where for any θϵR, let Bₙ(θ) be the number of positive pairs defined by (Equation 14):

$${B}_{n} ( θ ) = {\sum }_{i = 1}^{n} I ( {ϵ}_{i} ( θ ) > 0 )$$

where ϵᵢ(θ) is given by above and I(⋅) is the indicator function. Bₙ(θ) is the Binomial sign test statistic and can be equated to (Assumption 1):

Bₙ(θ*)˜Binomial(n,½)

For each scenario, experimental analysis system 114 can first generate the geo sizes z_{g} and the potential outcomes (S_{g}^{(C)}, S_{g}^{(T)}, R_{g}^{(C)}, R_{g}^{(R)}) for g∈{1, . . . , 2n} which lead to n geo pairs and are then kept fixed throughout the geo experiment. Within each scenario, the experimental analysis system 114 can then simulate K=10,000 randomized paired geo experiments by tossing a fair coin (i.e., randomizer) to decide which geo in the pair get assigned to the treatment group and which geo in the pair gets assigned to the control group—a process that determines which bivariate outcome (S_{g}, R_{g}) can be observed for each geo g. Note that the assignment mechanism may be the only source of randomization within each of the scenarios. As the input to all estimators, {(Xᵢ, Yᵢ): 1≤i≤n} can be calculated according to Xᵢ, Yᵢ equations above.

For each scenario reported in this section, in one example, the experimental analysis system 114 can use n=50 and sets θ*=10. The performance of a point estimator \hat{θ} is measured by the root mean square errors and bias, as follows (Equation 15):

$$RMSE ( \hat{θ} ) = \sqrt{\frac{1}{K} {\sum }_{k = 1}^{K} {( {\hat{θ}}^{( k )} - {θ}^{*} )}^{2}}$$

### and (Equation 16):

$$Bias ( \hat{θ} ) = \frac{1}{K} {\sum }_{k = 1}^{K} {\hat{θ}}^{( k )} - {θ}^{*}$$

where \hat{θ}^{(k)} is the estimated value of θ* from the kth replicate. The performance of a confidence interval can be measured by its power and empirical coverage, where the power can be defined to be the percent of replicates with lower confidence interval bounds greater than 0, and the empirical coverage is the percent of replicates with confidence intervals containing θ*.

The confidence interval (e.g., trimmed match confidence interval) can be constructed based on the minimal interval that contains all θ satisfying |T_{nλ}(θ)|≤c, where the threshold c can be determined based on P(|T_{nλ}(θ)|≤c)=1−α. That is, to determine the confidence interval the trimmed-match system 112 of FIG. 1 can let T_{nλ}(θ) be the studentized trimmed mean statistic with respect to {ϵ_{nλ}(θ): 1≤i≤n}, defined as follows (Equation 17):

$${T}_{n λ} ( θ ) = \frac{{\overline{ϵ}}_{n λ} ( θ )}{( \frac{{\hat{σ}}_{n λ} ( θ )}{\sqrt{n - 2 m - 1}} )}$$

where (Equation 18)

$${\hat{σ}}_{n λ}^{2} ( θ ) = \underline{{m [ {ϵ}_{( m + 1 )} ( θ ) ]}^{2} + {\sum }_{i = m + 1}^{n - m} {[ {ϵ}_{( i )} ( θ ) ]}^{2} + {m [ {ϵ}_{( n - m )} ( θ ) ]}^{2} - {n [ {\overline{ω}}_{n λ} ( θ ) ]}^{2}}$$

is the winsorized variance estimate for ϵ̅_{nλ}(θ), and (Equation 19)

$${\overline{ω}}_{n λ} = \frac{m \cdot {ϵ}_{( m + 1 )} ( θ ) + {\sum }_{i = m + 1}^{n - m} {ϵ}_{( i )} ( θ ) + m \cdot {ϵ}_{( n - m )} ( θ )}{n}$$

is the winsorized mean of ϵ₍ᵢ₎(θ)s.

When the distribution of {ϵ₍ᵢ₎(θ*):i=1, 2, . . . , n} is not too heavy tailed, the studentized trimmed mean statistic T_{nλ}(θ) is approximately t-distributed with n−2m−1 degrees of freedom. Therefore, in this case, a confidence interval for θ* can be constructed by choosing the critical value

$$c = {t}_{1 - \frac{α}{2} , n - 2 m - 1} , \\ where$$

$${t}_{1 - \frac{α}{2} , n - 2 m - 1}$$

$$is the 1 - \frac{α}{2}$$

quantile of t-distribution with (n−2m−1) degrees of freedom. Thus, it is adopted herein that the distribution of ϵ₍ᵢ₎(θ*) is symmetric about zero for i=1, . . . , n.

Accordingly, the experimental analysis system 114 can utilize Equation 15 to provide model performance comparison between \hat{θ}^{(binom)}, \hat{θ}^{(emp)}, and \hat{θ}^{(trim)} during the simulation scenario as shown in FIG. 3A and FIG. 3B. As shown, each model utilizes the same geographic dataset. However, the trimmed-match model (\hat{θ}^{(trim)}) has a small RMSE versus the other models (e.g., (\hat{θ}^{(binom)}) and (\hat{θ}^{(emp)})) indicative of the trimmed-match model providing improved accuracy to geo pairs during experimental analysis. As shown, due to heterogeneity, the empirical estimator (\hat{θ}^{(emp)}) may not be reliable. Also as shown, the binomial estimator (\hat{θ}^{(binom)}) may have more reliable but may be less efficient. Accordingly, the trimmed-match model (\hat{θ}^{(trim)}) can provide improved reliability and efficiency, since the trimmed-match model considers the sign (e.g., positive or negative) of the estimates and also the magnitude (e.g., size of the number/estimate). As disclosed above, reliability and efficiency can be determined based on the standard error of the subsets of geo pairs during experimental analysis.

In one example, if a random house in California (e.g., treatment) and a random house in Texas (e.g., control) is chosen (e.g., house pair), the price of each house may be symmetric about zero (i.e., well-matched, comparable). However, empirically, due to temporal dynamics (e.g., housing market, government policies, location, etc.), the difference in house price may not be close to zero. That is, if the California house is $1 million and the Texas House is $200,000 the difference would be $800,000 (e.g., not comparable). Thus, in this example, the price would not be symmetrical about zero. However, in a difference example, if thirty random house pairs were chosen and some were trimmed (i.e., depending on the equations discussed above, e.g., four house pairs trimmed), the empirical difference should be symmetrical about zero (or close to symmetrical about zero). Accordingly, the trimmed-match model (\hat{θ}^{(trim)}) can provide improved reliability and efficiency to outcome estimates that utilize comparable pairs (e.g., geo pairs) that considers the sign (e.g., positive or negative) of the estimates and also the magnitude (e.g., size of the number/estimate).

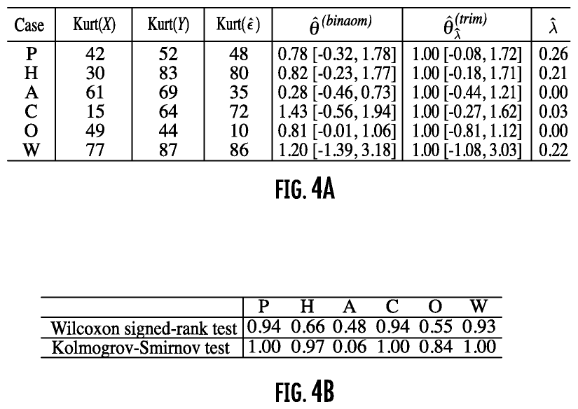

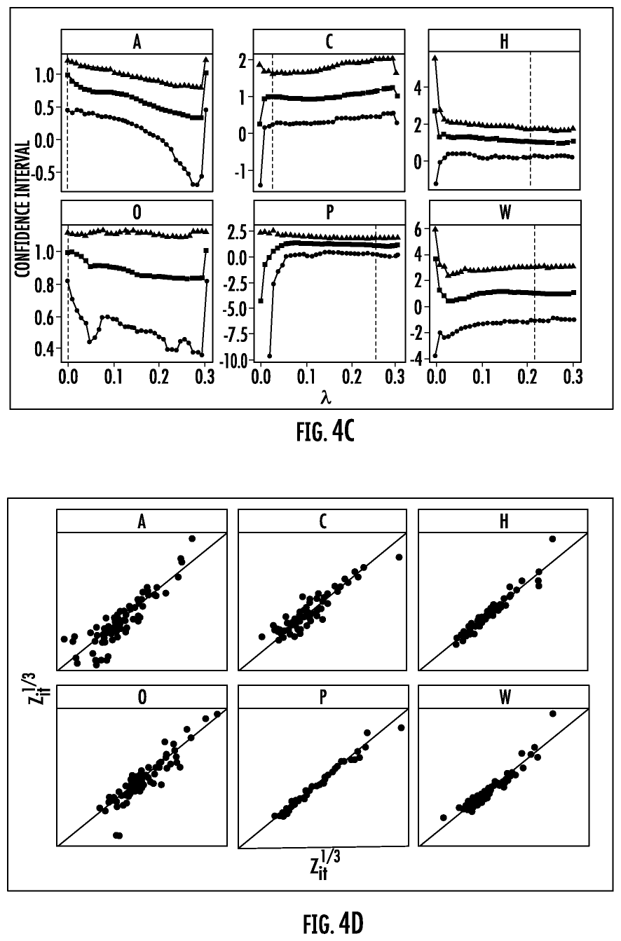

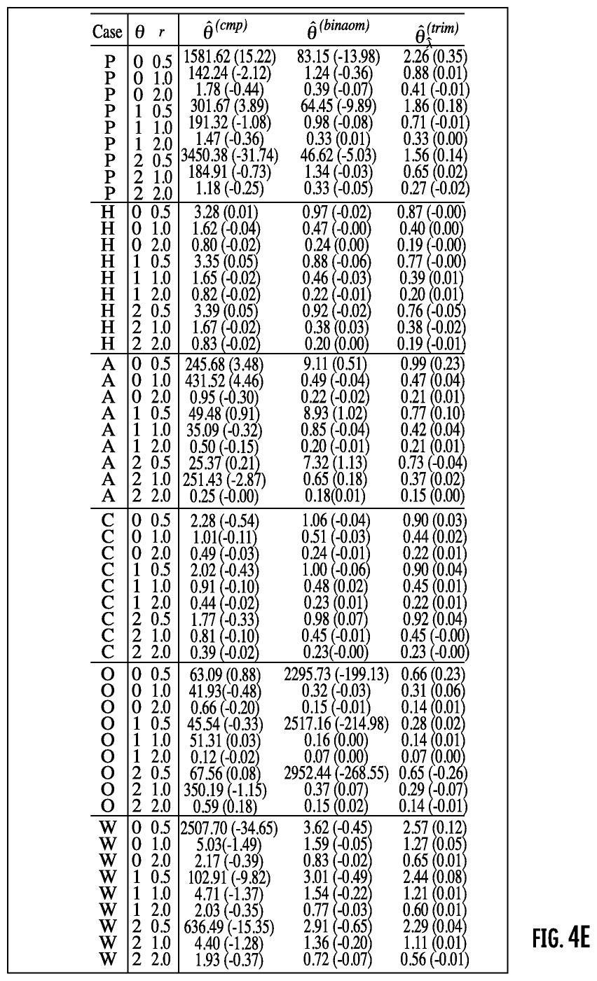

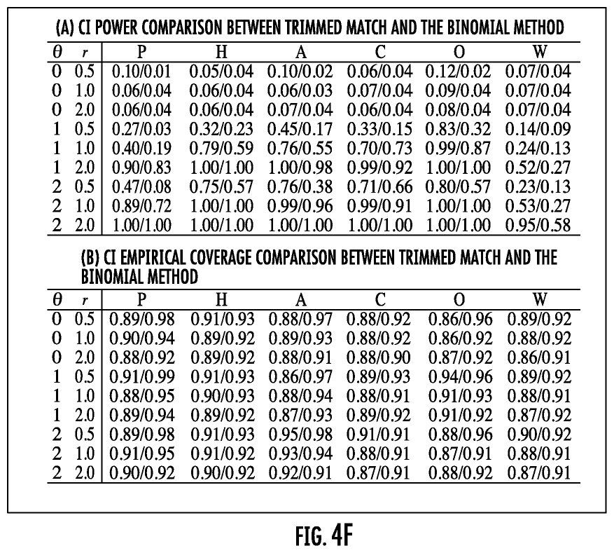

Referring to FIGS. 4A-4F, example model performance representations comparing the trimming model, binomial model, and the empirical model, according to illustrative implementations. In general, FIGS. 4A-4F are based on data from six different randomized geo experiments (e.g., P, H, A, C, O, W). Each geo experiment is based on the randomized paired design with 210 geographic regions (matched in 105 geo pairs). FIG. 4A is an example illustration of a kurtosis (i.e., tailedness of the probability distribution of real-valued random data) for the distributions of the sets, (K1) {Xᵢ: 1≤i≤n}, (K2) {Yᵢ: 1≤i≤n}, and (K3) {ϵᵢ(\hat{θ}_{\hat{λ}}^{(trim)}: 1≤i≤n}. That is, FIG. 4A is an example illustration depicting the predictions of \hat{θ}^{(binom)}, and \hat{θ}_{\hat{λ}}^{(trim)} and \hat{λ} and the confidence interval from the binomial model and trimmed model for each of the six geo experiments.

FIG. 4B is an example illustration of p-values from the Wilcoxon sign test (shown above) and the Kolmogrov-Smirnov test for each of the six different randomized geo experiments.

FIG. 4C is an example illustration of the predictions and confidence interval for each fixed A for each of the six experiment, where the vertical line corresponds to the trim rate A estimated according to Equation 10. For example, if there are 20 geo pairs, then k pairs may be trimmed, where k=1, 2, 3, . . . , 18, 19, 20 (n geo pairs). In this example, the value lambda (A) may correspond to

$$( \frac{k}{20} )$$

for some k (e.g.,

$$λ = \frac{1}{20} , \frac{2}{20} , \frac{3}{20} , … , \frac{18}{20} , \frac{19}{20} , \frac{20}{20} ) .$$

In FIG. 4C, the predictions and confidence intervals are recalled by \hat{θ}_{\hat{λ}}^{(trim)}.

FIG. 4D is an example illustration of a scatter plot of power-transformed (Zᵢₜ, Z_{ic}) on top of the identity line, where z^{1/3}=|z|^{1/3}·sign(z) and each dot is for a geo pair. In FIG. 4D, the power transform helps visualization with data heterogeneity, where each panel is for one of the six geo experiments.

FIG. 4E is an example illustration summarizing the comparison for each geo experiment with respect to RMSE and bias for \hat{θ}^{(binom)}, \hat{θ}^{(emp)}, and \hat{θ}_{\hat{λ}}^{(trim)}. As shown, in each case, \hat{θ}_{\hat{λ}}^{(trim)} has uniformly smaller (if not equal) RMSE than both \hat{θ}^{(binom)}, and \hat{θ}^{(emp)}. When r=0.5 both \hat{θ}^{(binom)}, and \hat{θ}^{(emp)} can have large RMSEs (10-100 times larger than \hat{θ}_{\hat{λ}}^{(trim)}) When r grows from 0.5 (low incremental content input) to 2 (high incremental content input), the RMSEs are reduced for all models, as expected. Also as shown, for each case, the bias is only a small fraction of RMSE for all models, especially \hat{θ}_{\hat{λ}}^{(trim)}.

FIG. 4F is an example illustration summarizing the comparison of confidence interval for each geo experiment between \hat{θ}^{(binom)} and \hat{θ}_{\hat{λ}}^{(trim)} with respect to power and empirical coverage. As shown, when θ=0, for each model, the power is close to 0 for r∈{0.5,1, 2}. Also as shown, for each θ∈{1,2}, the power grows up to 1.0 quickly as r increases from 0.5 to 2.0 for both models, but trimmed match has uniformly better power than the binomial model. Further as show, empirical coverage of the binomial model is equal to or above the nominal level 90%. For trimmed match, the empirical coverage is lower than 90%, since it does not take into account the variability in the trim rate.

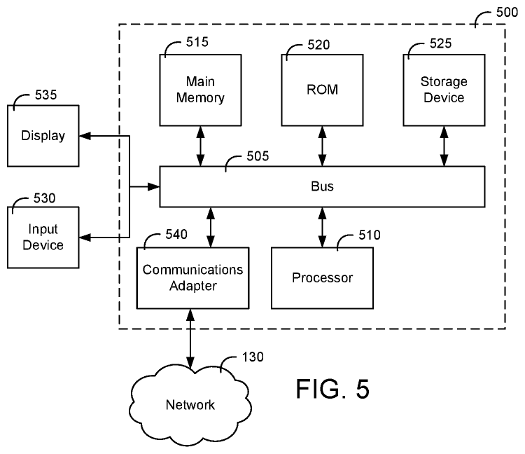

FIG. 5 illustrates a depiction of a computer system 500 that can be used, for example, to implement an illustrative user device 140, an illustrative content provider device 150, an illustrative geographic experiment system 110, and/or various other illustrative systems described in the present disclosure. The computing system 500 includes a bus 505 or other communication component for communicating information and a processor 510 coupled to the bus 505 for processing information. The computing system 500 also includes main memory 515, such as a random-access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid-state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 130 and/or other computing systems. In various illustrative implementations, any type of networking configuration may be achieved using communications adapter 540, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer-readable storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks, distributed ledger networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TELEVISION channel, on a satellite TELEVISION channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, Disney+, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a smart watch, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method of preparing experimental datasets for experimental analysis systems, the method comprising:
identifying, by one or more processing circuits, a dataset of a plurality of geographic pairs associated with a geo experiment, the dataset of the plurality of geographic pairs comprising input data, response data, and location identifiers associated with each geographic region, wherein the response data is a result of an action associated with the input data, and wherein each geographic pair of the dataset of the plurality of geographic pairs comprises a first geographic region associated with a treatment subset and a second geographic region associated with a control subset;
calculating, by the one or more processing circuits, a difference in input data and a difference in response data between the first geographic region and the second geographic region of each geographic pair;
calculating, by the one or more processing circuits, a plurality of outcome estimates based on the difference in response data and the difference in input data for each of a plurality of different subsets of geographic pairs, wherein each output estimate comprises a different subset of geographic pairs, and wherein each subset of geographic pairs comprises a different number of geographic pairs;
selecting, by the one or more processing circuits, a first subset of geographic pairs of the plurality of different subsets of geographic pairs based on a first outcome estimate of the plurality of outcome estimates that is about a prespecified value on the outcome estimates; and
providing, by the one or more processing circuits, the selected subset of geographic pairs.

2. The method of claim 1, further comprising:
generating, by the one or more processing circuits, one or more predictions based on the selected subset of geographic pairs.

3. The method of claim 2, wherein the one or more predictions are based on a bivariate analysis, the bivariate analysis comprising an empirical relationship between each geographic pair, the empirical relationship indicative of an association prediction of each geographic pair and a difference prediction of each geographic pair.

4. The method of claim 2, further comprising:
in response to generating the one or more predictions, sending, by the one or more processing circuits to an entity computing device, an entity notification including the one or more predictions and the selected subset of geographic pairs.

5. The method of claim 1, wherein selecting the first subset of geographic pairs of the plurality of different subsets of geographic pairs further comprises determining a fixed trim rate based on the minimizing a plurality of asymptotic variances.

6. The method of claim 5, wherein calculating the plurality of asymptotic variances of the dataset of the plurality of geographic pairs further comprises calculating an asymptotic variance for each of the plurality of different subsets of geographic pairs.

7. The method of claim 6, wherein each asymptotic variance is associated with at least one of the response data, the input data, or the location identifiers.

8. The method of claim 1, wherein the first geographic region associated with the treatment subset and the second geographic region associated with the control subset is randomly selected from each geographic pair.

9. A system comprising:
at least one processing circuit configured to:
identify a dataset of a plurality of geographic pairs associated with a geo experiment, the dataset of the plurality of geographic pairs comprising input data, response data, and location identifiers associated with each geographic region, wherein the response data is a result of an action associated with the input data, and wherein each geographic pair of the dataset of the plurality of geographic pairs comprises a first geographic region associated with a treatment subset and a second geographic region associated with a control subset;
calculate a difference in input data and a difference in response data between the first geographic region and the second geographic region of each geographic pair;
calculate a plurality of outcome estimates based on the difference in response data and the difference in input data for each of a plurality of different subsets of geographic pairs, wherein each output estimate comprises a different subset of geographic pairs, and wherein each subset of geographic pairs comprises a different number of geographic pairs;
select a first subset of geographic pairs of the plurality of different subsets of geographic pairs based on a first outcome estimate of the plurality of outcome estimates that is about a prespecified value on the outcome estimates; and
provide the selected subset of geographic pairs.

10. The system of claim 9, wherein the at least one processing circuit further configured to:
generate one or more predictions based on the selected subset of geographic pairs.

11. The system of claim 10, wherein the one or more predictions are based on a bivariate analysis, the bivariate analysis comprising an empirical relationship between each geographic pair, the empirical relationship indicative of an association prediction of each geographic pair and a difference prediction of each geographic pair.

12. The system of claim 10, wherein the at least one processing circuit further configured to:
in response to generating the one or more predictions, send, to an entity computing device, an entity notification including the one or more predictions and the selected subset of geographic pairs.

13. The system of claim 9, wherein selecting the first subset of geographic pairs of the plurality of different subsets of geographic pairs is further configured to determine a fixed trim rate based on the minimizing a plurality of asymptotic variances.

14. The system of claim 13, wherein calculating the plurality of asymptotic variances of the dataset of the plurality of geographic pairs is further configured to calculate an asymptotic variance for each of the plurality of different subsets of geographic pairs, and wherein each asymptotic variance is associated with at least one of the response data, the input data, or the location identifiers.

15. The system of claim 9, wherein the first geographic region associated with the treatment subset and the second geographic region associated with the control subset is randomly selected from each geographic pair.

16. The system of claim 9, wherein the first geographic region and the second geographic region are associated with a target population.

17. One or more non-transitory computer-readable storage media having instructions stored thereon that, when executed by at least one processing circuit, cause the at least one processing circuit to perform operations comprising:
identifying a dataset of a plurality of geographic pairs associated with a geo experiment, the dataset of the plurality of geographic pairs comprising input data, response data, and location identifiers associated with each geographic region, wherein the response data is a result of an action associated with the input data, and wherein each geographic pair of the dataset of the plurality of geographic pairs comprises a first geographic region associated with a treatment subset and a second geographic region associated with a control subset;
calculating a difference in input data and a difference in response data between the first geographic region and the second geographic region of each geographic pair;
calculating a plurality of outcome estimates based on the difference in response data and the difference in input data for each of a plurality of different subsets of geographic pairs, wherein each output estimate comprises a different subset of geographic pairs, and wherein each subset of geographic pairs comprises a different number of geographic pairs;
selecting a first subset of geographic pairs of the plurality of different subsets of geographic pairs based on a first outcome estimate of the plurality of outcome estimates that is about a prespecified value on the outcome estimates; and
providing the selected subset of geographic pairs.

18. The one or more non-transitory computer-readable storage media of claim 17, the operations further comprising:
generating one or more predictions based on the selected subset of geographic pairs; and
in response to generating the one or more predictions, sending, to an entity computing device, an entity notification including the one or more predictions and the selected subset of geographic pairs.

19. The one or more non-transitory computer-readable storage media of claim 18, wherein the one or more predictions are based on a bivariate analysis, the bivariate analysis comprising an empirical relationship between each geographic pair, the empirical relationship indicative of an association prediction of each geographic pair and a difference prediction of each geographic pair.

20. The one or more non-transitory computer-readable storage media of claim 17, wherein selecting the first subset of geographic pairs of the plurality of different subsets of geographic pairs further comprises determining a fixed trim rate based on the minimizing a plurality of asymptotic variances.
